(19) United States
(12) Patent Application Publication
(10) Pub. No.: US 2024/0109126 A1
(43) Pub. Date: Apr. 4, 2024

(54) PRINTHEAD AND METHOD FOR ADDITIVE MANUFACTURING OF A COMPONENT USING MOLTEN METAL

(71) Applicant: GROB-WERKE GmbH & Co. KG, Mindelheim (DE)

(72) Inventors: Johannes GLASSCHRÖDER, Neusäß (DE); Oliver LEUSCH, Augsburg (DE); Christian MIKLEC, Bad Wörishofen (DE); Benjamin HIMMEL, München (DE); Andreas LANG, Ettringen (DE); Martin OTTER, Memmingen (DE)

(21) Appl. No.: 18/285,418

(22) PCT Filed: Mar. 30, 2022
(86) PCT No.: PCT/EP2022/058433

§ 371 Date: Oct. 3, 2023

(30) Foreign Application Priority Data
Jun. 28, 2021 (DE) 10 2021 116 623.3

(51) Int. Cl. B22F 10/22; B22F 12/53; B22F 12/57

(52) U.S. Cl. CPC B22F 10/22; B22F 12/53; B22F 12/57; B33Y 30/00

(57) ABSTRACT

A printhead (1) for printing molten metal for additive manufacturing of a component includes a nozzle component (10) having a nozzle outlet opening (12), a piston (14; 14a) that ejects the molten metal through the nozzle outlet opening (12), an actuator assembly (16; 16a) having an actuator, and a biasing element. By actuating the actuator, the piston (14; 14a) is movable in an actuation direction (y) from an extended position to a retracted position, in which a first piston end (18) that faces the nozzle outlet opening (12) is farther away from the nozzle outlet opening (12) than in the extended position. The biasing element (26; 26a) biases the piston (14; 14a), at least when it is located in the retracted position, back toward the extended position.

### CROSS-REFERENCE

This application is the US national stage of International Patent Application No. PCT/EP2022/058433 filed on Mar. 30, 2022, which claims priority to German Patent Application No. 10 2021 116 623.3 filed on Jun. 28, 2021.

### TECHNICAL FIELD

The present disclosure relates to a printhead for the printing of molten metal for the additive manufacturing of a component and to a method for the operation of such a printhead for the additive manufacturing of a component using molten metal. In particular, the printhead and the method are provided for the usage in the additive manufacturing technology Liquid Metal Printing (LMP).

### BACKGROUND ART

Printheads known in the prior art include a piston, using which the material to be printed is ejected from a nozzle. Here, the piston is preferably moved in the ejection direction towards a nozzle outlet opening by using a piezoelectric actuator, whereby a droplet is generated when the material is ejected. Subsequently, the piston is returned to its rest position by a spring, wherein new material flows from a reservoir into the piston channel during the return movement and compensates (replenishes) the previously discharged material. Such a printhead is known, for example, from WO 2020/120317 A1.

In conventional printheads, the actuation and in particular the flow of the printing material can lead to a dynamic in the piston channel that leads to an oscillation of the printing material; in particular an oscillation of the liquid meniscus can be induced at the nozzle outlet. Such oscillations, especially when they interfere, can lead to quality degradation during printing due to, for example, undesired droplet generation or droplet generation in not defined size, etc.

For example, a wide variety of printing parameters (piston speed, amplitude or decay time (dwell time in a rest position)) or geometries can be adapted (adjusted) to prevent or reduce the oscillations, but the majority of measures lead to various other adverse effects, such as reduction of the maximum possible droplet delivery frequency or problems in the generation of defined droplets (droplets having predetermined size).

In WO 2020/169260 A1, a so-called inverse actuation method of a conventional printhead is described for improving the droplet generation. In this inverse actuation process, the piston is moved, starting from a rest position, away from the nozzle outlet opening in a first step to load the piston channel and then moved back in a second step toward the nozzle outlet opening to its rest position or beyond. Thus, the loading of the piston channel always occurs from the rest position and immediately before the generation of the droplet, whereby oscillations can be reduced or avoided. Accordingly, in this actuation method, the piezoelectric, which is provided to actuate the piston, is at least partially charged in the rest position of the piston, is then discharged in the first step, and is charged again in the second step.

### SUMMARY

It is one non-limiting object of the present disclosure to provide techniques for improving a printhead for printing, e.g., liquid molten metal for additive manufacturing of a component, such that a high quality of droplet generation at high speed and good durability of the printhead can be achieved. Another non-limiting object is to provide a corresponding method for operating such a printhead.

In one aspect of the present teachings, a printhead for printing molten metal for additive manufacturing of a component may include a nozzle component having a nozzle outlet opening, a piston configured to eject the molten metal through the nozzle outlet opening, an actuator assembly having an actuator, and a biasing element. By actuating the actuator, the piston is movable in an actuation direction (y) from an extended position to a retracted position, in which a first piston end that faces the nozzle outlet opening is farther away from the nozzle outlet opening than in the extended position. In addition, the biasing element biases the piston, at least when the piston is located in the retracted position, towards the extended position.

Such a printhead is preferably provided for printing molten metal for additive manufacturing of a component, but in other embodiments of the present teachings can also be provided for printing in non-additive manufacturing or for printing other liquid materials such as plastics in both the additive and non-additive manufacturing.

The nozzle component is preferably provided in a replaceable manner. Alternatively, the nozzle component can, for example, be integrally formed with another component, such as the crucible or a piston guide component for guiding the piston. The nozzle component is preferably a nozzle plate, in which the nozzle component through hole is preferably provided substantially perpendicularly to the planar extension of the nozzle plate. The nozzle component is preferably held on the piston guide component in a preferably replaceable manner.

The piston guide component, if provided, is preferably provided in a replaceable manner. The piston guide component is preferably attached or formed in the bottom hole of the crucible. In an embodiment in which the nozzle component integrally forms the piston guide component, the nozzle component is preferably provided in a replaceable manner, preferably on the crucible.

Preferably, the piston channel serves to movably guide the first piston end that faces or is proximal to the nozzle outlet opening. Preferably, the piston channel is formed by the piston guide component. Alternatively, the piston channel can be formed by the nozzle component alone or by the nozzle component and the piston guide component together. Preferably, the nozzle outlet opening has a smaller diameter than the piston channel.

Preferably, the piston channel at least partially forms a loading chamber. Preferably, at least a portion of the piston channel forms the loading chamber, which is formed between the first piston end in the retracted position and the first piston end in the extended position of the piston. Thus, the loading chamber preferably corresponds to the displacement of the piston on the side of the first piston end. When the piston moves from the retracted position to the extended position, the volume of the loading chamber is preferably reduced to zero, so that, when there is printing material, preferably molten metal, in the loading chamber, it is driven out. Preferably, the loading chamber is formed immediately adjacent to the nozzle component through hole so that the driven out material and/or material present in the nozzle component through hole is immediately discharged or ejected as droplets from the nozzle outlet opening. Alternatively, for example, the possibly further course (path) of the piston channel formed between the loading chamber and the nozzle outlet opening and/or an inner space of the nozzle component through hole is filled with printing material, preferably the molten metal, so that the printing material, preferably the molten metal, present in the nozzle component through hole in front of the nozzle outlet opening is discharged or ejected as droplets from the nozzle outlet opening by the driving out impulse onto the material present in the loading chamber. Alternatively, the loading chamber can be defined as the chamber between the piston in the retracted position and the nozzle outlet opening.

The retracted position corresponds to the upper position of the piston when ejecting downwards in the direction of the weight force. The extended position corresponds to the lower position. The retracted position and the extended position can be varied as required; i.e. they need not correspond to the respective maximum approachable position. Thereby, the stroke volume, the distance to the nozzle outlet opening in the respective positions, etc. can be adjusted accordingly.

The actuator assembly preferably includes at least the actuator. The actuator is preferably configured at least to move the piston from its extended position to its retracted position. In particular, the actuator is preferably configured such that the piston can move from its extended position to its retracted position by supplying energy or by starting an energy supply. Alternatively, it is configured such that it can move the piston from its extended position to its retracted position by increasing the supply of energy. Optionally, it can additionally be configured to move the piston from its retracted position back to its extended position or to support (assist) this movement back, if necessary, by supplying further energy or by active energy dissipation. The actuator is, for example, an electromotive actuator (e.g., an electric motor that moves the piston via a drive mechanism (e.g., a gearwheel-gear rack)), an electromagnetic actuator (coil armature), a pneumatic or hydraulic actuator or, even more preferably, a piezoelectric actuator, in this case preferably a piezoelectric stack or a ring piezoelectric (piezoelectric stack that is formed in ring shape). The function, control and operating methods of the individual possible actuators take place in known ways, so that no further explanation is given in this respect. The actuator is preferably an actuator that can exert a force on the piston in the direction away from the nozzle outlet opening by supplying energy (when actuated).

In an embodiment in which the actuator is a piezoelectric actuator, it is preferably configured so that the piezoelectric actuator is expandable starting from a first length to a second length in the (its) actuation direction (y) by applying energy (preferably by applying or increasing a voltage across the piezoelectric). Furthermore, the piezoelectric actuator is preferably arranged and coupled to the piston so that the piston is moved from the extended position to the retracted position as the piezoelectric actuator expands from the first length to the second length.

The biasing element is formed, for example, as a spring (coil spring, disc spring, etc.), rubber spring, air spring, gas spring, etc. The biasing element can be formed as a compression spring or a tension spring. Depending on the configuration of the actuator, the biasing element is formed, for example, so that it assists the movement of the piston from the retracted to the extended position. In such a case, the actuator also supplies a force to move the piston from the retracted position to the extended position. Preferably, depending on the configuration of the actuator, the biasing element can be formed so that the biasing element first brakes the piston after switching off or reducing the energy supply to the actuator (after the end of the actuation of the actuator) and then alone moves the piston back to the extended position for moving of the piston from the extended position to the retracted position. In this case, the energy required to eject/generate a droplet, inclusive of the energy/friction required for the return movement of the actuator, is provided by the biasing element alone or exclusively. The biasing element is preferably configured so that it applies a biasing force to the piston or to the actuator or to the piston attachment in both the retracted and extended positions.

In an alternative embodiment of the present teachings, no biasing element is provided. In such a case, an actuator is preferably used that performs both the movement from the extended position to a retracted position as well as the return movement. Preferably, such an actuator is an actuator that achieves the movement of the piston from the extended position to a retracted position by increasing its length in the direction of actuation, such as a double-acting pneumatic actuator. In such an embodiment, of course, the actuator must be attached to the housing such that both tensile- and compressive forces can be applied to the piston. A simple support is not sufficient here.

In a preferred embodiment, the actuator is a piezoelectric actuator and the force for the return movement of the piston is supplied by the biasing element alone (the force generated by discharging the piezoelectric at the piezoelectric itself is neglected here). In this case, the voltage applied to the piezoelectric actuator is switched off to realize the return movement to the extended position and the piezoelectric is discharged. Alternatively, the piezoelectric actuator can assist the return movement by the piezoelectric actuator by applying, at least for a short time, a voltage having a sign opposite to the first voltage (charging voltage). The piezoelectric actuator is thus preferably actively discharged and/or charged with opposite signs so that it returns to its initial position and can thereby assist the biasing element or at least does not counteract it.

The loading chamber preferably fills during the movement of the piston from the extended position to the retracted position by (in response to) the volume that becomes available in the loading chamber. For this purpose, as is known in the prior art, preferably at least one filling channel is formed, through which material to be printed that is provided in a supply reservoir, can be supplied into the loading chamber. The material to be printed, for example, either moves independently owing to gravity or is pressurized or is supplied using a conveying unit (e.g. pump). The filling channel is preferably open at least in the retracted position of the piston, but can for example also be open already in a range of movement of the piston before the retracted position. For example, the supply reservoir is formed by the crucible and, for example, a plurality of slot-shaped recesses (overflow channels) is provided as fluid channels in the outer wall of the piston channel such that, when the piston is located in the retracted position, a connection to the interior of the crucible (or supply reservoir) is provided between the piston channel inner wall and the piston through the slot-shaped recesses. Alternatively or additionally, the slot-shaped recesses can be provided in the outer surface of the piston.

The filling of the loading chamber can, for example, be ended when the piston reaches the (its) retracted position; i.e. no further filling of the loading chamber takes place in the subsequent (return) movement of the piston from the retracted position to the extended position. Alternatively, the filling of the loading chamber can, for example, be ended already during the movement of the piston from the retracted position to the extended position, in particular in, for example, a first range of movement (for example, a first range of movement which is preferably less than 30% and greater than 2%, still preferably less than 20% and greater than 10%, such as 10%, 15% or 17%, of the total range of movement of the piston from the retracted position to the extended position). In particular, this is preferably the case if, during the movement of the piston from the extended position to the retracted position, vapor bubbles form in the material to be printed, which is still present in the piston channel or in the nozzle component through hole, and these bubbles collapse already during the return movement.

In particular, the biasing element is elastically deformable in its biasing direction. In its biasing direction, the biasing element preferably has a first end that is supported on (for example, abuts against or is affixed to) the housing of the printhead. At its second end that is opposite to the first end in the biasing direction, the biasing element is preferably supported directly or indirectly (via another component) on the piston. The biasing direction preferably corresponds to the actuation direction of the actuator in the opposite direction. In a first example, the biasing element is disposed and formed so that it biases the piston, in particular the second end of the piston, which is located in the retracted position, with a force in the direction towards the nozzle outlet opening and expands or elastically deforms as the piston moves in the extended position such that its extension increases in the direction of the nozzle outlet opening. The biasing element is thus preferably compressed when the piston is located in the retracted position. Particularly preferably, the biasing element is also compressed when the piston is located in the extended position, only to a lesser extent than when the piston is located in the retracted position. Preferably, in the first example, the biasing element is a compression spring. Conversely, in a second example, the biasing element can be disposed and formed such that it biases the piston, which is located in the retracted position, in particular the second piston end, with a force in the direction (actuation direction y) towards the nozzle outlet opening and contracts or elastically deforms as the piston moves in the extended position such that its extension decreases in the direction towards the nozzle outlet opening (actuation direction y). The biasing element is thus expanded when the piston is located in the retracted position. In this case, the biasing element is preferably a tension spring. Depending on the configuration of the biasing element and other parameters, such as the deflection from the rest position, the biasing element can be provided without tension when the piston is located in the maximum extended position, with lesser biasing in the same direction or with biasing in the other direction.

For example, the actuator, in particular when it is embodied as a piezoelectric actuator, is supported on or affixed to the actuator or printhead housing at its end facing the nozzle outlet opening (in the actuation direction). The (second) end that is opposite in the actuation direction is preferably supported on or affixed to the piston attachment and/or to one of the ends of the biasing element. The piston attachment ultimately serves to connect the piston to the second end of the actuator and to the biasing element and can be integrally formed with or can be separate from the piston, the biasing element or the actuator. For example, the biasing element can be located behind the actuator, as viewed in the actuation direction starting from the nozzle outlet opening. In this case, it is compressed when the piston is located in the retracted position and is not compressed or is less compressed when the piston is located in the extended position. Alternatively, the biasing element can, for example, be provided in front of the end of the actuator that faces away from the nozzle outlet opening, as viewed in the actuation direction. Here, the first end, as viewed in the actuation direction starting from the nozzle outlet opening, is also preferably affixed to the actuator housing, and the second end, as viewed in the actuation direction starting from the nozzle outlet opening, is affixed to the actuator. The biasing element is thus preferably provided in parallel and radially overlapping with the actuator. In this case, it is expanded when the piston is located in the retracted position and is not expanded or is less expanded when the piston is located in the extended position, i.e. it is preferably formed as a tension spring.

Preferably, the actuator is designed as a piezoelectric stack that is arranged substantially in extension to the piston. In this case, the piston attachment preferably extends parallel to the piezoelectric stack; preferably it is formed in a hollow cylindrical manner and surrounds the piezoelectric stack radially with reference to the actuation direction.

In another example, the actuator is formed as a ring piezoelectric (ring-shaped piezoelectric/piezoelectric stack) that surrounds the piston at least partially radially, i.e. perpendicular to the actuation direction. In this case, the piston attachment can be formed, for example, as a circular disc, which connects the second end of the ring piezoelectric with the end of the piston that faces away from the nozzle outlet opening. In addition, the biasing element, in particular when the biasing element is formed as a compression spring, can be supported on the side of the piston attachment that faces away from the nozzle outlet opening.

The piston and/or the piston attachment and/or the biasing element can, for example, be formed so that the retracted position and/or the extended position are approached completely without mechanical stops (freely-oscillating system). Alternatively, mechanical stops can be provided on one or both sides, for example, such that the extended position and/or the retracted position is/are defined via a respective stop. In addition, the stop in the extended position can be realized, in particular by the actuator, especially the piezoelectric actuator.

Preferably, a controller is also provided, using which the actuator is controllable to generate and/or eject a droplet. In particular, using the controller a voltage is appliable directly or indirectly to an actuator in the form of a piezoelectric actuator.

Preferably, the controller is configured and/or the actuator is controlled so that each individual operation to generate an individual droplet proceeds basically as follows. In a first step, the piston is accelerated by actuation of the actuator starting from a first position (initial position), which preferably corresponds to the extended position of the piston, toward the retracted position. Subsequently, the piston is decelerated by the biasing element owing to a reduced actuation or ending of the actuation of the actuator and then accelerated in the opposite direction so that the movement direction of the piston is reversed (preferably immediately, i.e. without remaining there) in a second position (reversal point, top dead center) and it is moved back toward the first position by the biasing element. In this return movement, a droplet is generated in or at the nozzle opening due to the displacement of the material in the loading chamber and the impulse, if any, associated therewith on the material present in front of the loading chamber, and ejected. Either the actuator is preferably actuated before reaching the first position such that the movement of the piston toward the first position is braked and the piston preferably comes to a standstill in the first position, or a corresponding stop is provided, for example, by the actuator or a separate component, so that the piston preferably comes to a standstill in the first position. Thus, the first position also represents a reversal point and/or the bottom dead center.

To generate the next droplet in a printing process, in which multiple droplets are generated in succession, the above first step is started again, i.e. the actuator is actuated again such that the piston is moved again from the first position toward the second position. Depending on the embodiment and the requirements, the actuator is either controlled such that the piston remains stationary (dwells at rest) a predetermined time period (decay time) in the first position before the start of the generation of the next droplet before the actuation to move toward the second position, or is controlled such that the generation of the next droplet immediately follows the generation of the previous droplet. In the latter case, the predetermined time period (decay time) is substantially zero. The position is therefore also referred to as the rest position or the decay position.

The quality of the droplets can be significantly increased by droplet generation that is controlled in this way, since a second, third or nth droplet generation process, which follows a first droplet generation process, is also respectively started in a system in which oscillations are minimized or are substantially non-existent. Reasons therefor are, on the one hand, the small or non-existent amount of liquid between the piston and the nozzle outlet opening when the piston is located in the first position, which leads to low oscillation energy, and, on the other hand, the decay time preceding the new droplet generation, during which any oscillations that may still be present can decay.

The minimized or substantially non-existent oscillations at the start of each droplet generation process, even in a series of droplet generation processes, lead to each droplet generation process taking place starting from a constant initial position. The actuation process for loading of the loading chamber and the subsequent return movement for generating and ejecting the droplet can thereby be optimized without oscillations originating from previous droplet generation operations interfering with the process. In turn, droplets can therefore be generated at a higher maximum frequency.

The movement speeds or accelerations of the piston can be individually adjusted or designed in both directions, on the one hand by the selection of the actuator and on the other hand by the selection of the biasing element. In particular, to minimize or eliminate the oscillations before the start of the subsequent process for droplet generation, the movement speed of the piston from the first position to the second position to load the loading chamber is decisive. The faster the movement is, the more oscillations are induced in the loaded system. Conversely, by providing or increasing the decay time, such oscillations can be counteracted. Decay time and speed must therefore be attuned to each other in accordance with the application and system design.

Preferably, the actuator is controlled such that it requires, at preferably the maximum permissible operating frequency, 50% to 95%, preferably 60% to 90%, and more preferably 70% to 90%, such as 70% or 80%, of the total movement time, which the piston requires for the movement from the first position to the second position and back to the first position (i.e., excluding the decay time), for the movement from the first position to the second position. Thus, the movement time from the first position to the second position is preferably equal to, or even more preferably longer than, the movement time from the second position back to the first position.

At preferably the maximum permissible operating frequency, the decay time is preferably 0% to 70%, more preferably 0% to 60%, and even more preferably 0% to 50%, such as 0% or 20% or 50%, of the total duration of each operation of the droplet generation (movement from the first position to the second position and back again (total movement time) plus the decay time). Alternatively, at preferably the maximum allowable operating frequency, the decay time is preferably 0% to 70%, more preferably 10% to 60%, and even more preferably 20% to 50%, such as 20% or 40% or 50%, of the total duration of each droplet generation operation (movement from the first position to the second position and back again (total movement time) plus the decay time).

Preferably, the printhead is configured such that, at preferably the maximum permissible operating frequency, droplets are ejectable at a (maximum) frequency of preferably up to 500 Hz, more preferably up to 1000 Hz and even more preferably up to 1500 Hz, such as, e.g., 500 Hz or 1000 Hz. The specified frequencies are preferably the respective maximum or maximal permissible operating frequencies. Depending on the application, the particular printhead can of course be driven at lower frequencies.

All parameters of the printhead, in particular the frequency, decay time and movement time for the first movement to the second position and the second movement back to the first position, are preferably attuned to each other such that at the beginning of each droplet generation process the system, in particular the liquid present in front of the piston in the nozzle component through-hole, is essentially oscillation-free. The adjustment of the parameters can be determined by simple simulation or experiments.

In the case of the exemplary 500 Hz, 2 ms are available for each operation to generate a droplet. If no decay time is provided, the actuator is accordingly preferably controlled such that it is preferably moved from the first position to the second position in 1 ms to 1.9 ms and accordingly moved from the second position to the first position in 1 ms to 0.1 ms. At a decay time of 1 ms (50% of the total duration), the actuator is accordingly preferably controlled such that it is preferably moved from the first position to the second position in 0.5 ms to 0.95 ms and accordingly moved from the second position to the first position in 0.5 ms to 0.05 ms. At higher frequencies, the times become correspondingly shorter.

The first position preferably corresponds to the extended position or lies between the retracted position and the extended position. The second position preferably corresponds to the retracted position or lies between the retracted position and the extended position on the side of the retracted position with reference to the first position. The positions can be varied as required.

The stroke of the piston during actuation is preferably between 5 μm and 55 μm, more preferably between 10 μm and 45 μm and even more preferably between 15 μm and 40 μm, such as 20 μm, 25 μm or 30 μm. The diameter of the piston is preferably between 2 mm and 10 mm, more preferably between 4 mm and 7 mm and even more preferably between 5 mm and 6 mm, such as 5.7 mm, 5.8 mm or 5.9 mm. For example, for an actuation of 26 μm and a piston diameter of 5.8 mm, the droplet size is in the range of 500 μm.

For example, a piezoelectric stack 80-AE0707D44H40DF of the company KEMET or a ring piezoelectric is used as the actuator.

Furthermore, the present disclosure relates to a printing system that, in addition to the above- and below-described printhead, preferably includes a relative movement device (such as, for example, a robot arm that is movable in multiple directions or a motor-drivable worktable), using which the printhead is movable relative to a workpiece surface to be printed. Preferably, the printing system includes another controller for controlling the relative movement device, or the actuator and the relative movement device have a common controller. In addition, preferably a supplying device is provided for supplying the raw material, for forming the melt in the crucible or for supplying already liquid (molten) melt into the crucible. Alternatively to the crucible, the melt can also be supplied directly into the loading chamber.

It goes without saying that the above exemplary or preferred configurations are freely combinable with each other as long as it is not explicitly excluded or is not possible.

The printhead is preferably configured such that, for each droplet generation, the loading of the loading chamber takes place in a first step by moving the piston from the extended position to the retracted position and then, in a second step, the droplet is generated and/or ejected by the return movement of the piston to the extended position. Owing to the inverse droplet generation realized in this way, oscillations in the material to be printed can be minimized. Oscillations can preferably be further minimized by preferably not actuating the actuator before the first step and/or after the second step during the decay time, so that the piston can dwell in its extended position or can swing out to this position. The extended position is accordingly also referred to as the rest position.

The actuator is therefore located in its rest position when the piston is located in the rest position. Owing to the fact that the actuator is not actuated when the piston is located in the rest position, i.e. in the extended position, the stress on and thus the service life of the actuator and, if applicable, of the controller, is improved. This is particularly the case, for example, when using piezoelectric actuators that are discharged in their rest position.

### BRIEF DESCRIPTION OF THE DRAWINGS

Exemplary embodiments are explained below with reference to the figures, of which:

FIG. 1 shows a partial sectional perspective and schematic view of a printhead according to a first embodiment,

FIG. 2 shows a simplified schematic illustration of an actuator assembly according to the first embodiment of the printhead, and

FIG. 3 shows a simplified schematic illustration of an actuator assembly according to a second embodiment of the printhead.

### DETAILED DESCRIPTION

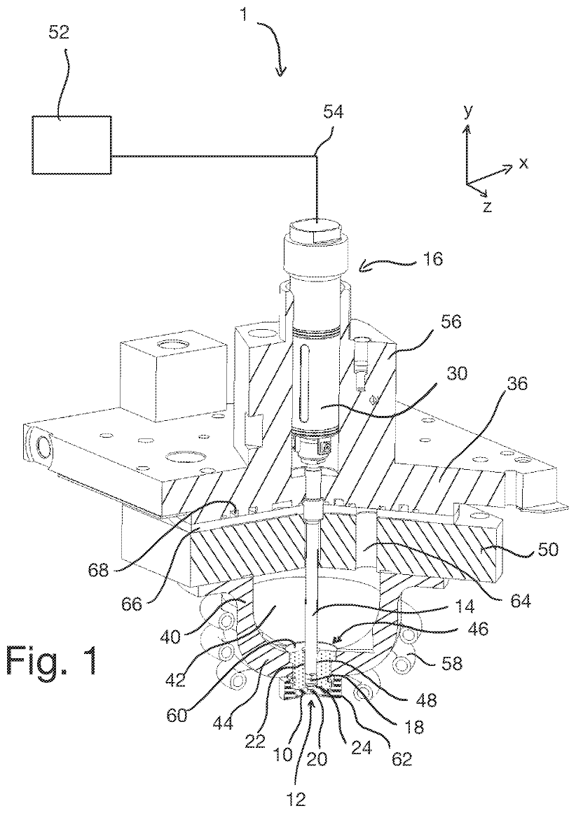

FIG. 1 shows a printhead 1 according to a first embodiment for printing of molten metal for additive manufacturing of a component. According to the coordinate system shown in FIG. 1, the printhead 1 has a height in a y-direction, a width in an x-direction and a depth in a z-direction. The printhead has a printhead housing 36. In the present embodiment, the printhead housing 36 is basically plate-shaped in an x-z plane spanned by the x-direction and the z-direction. For example, the printhead housing 36 is configured to be affixed to a not-shown robot arm to move the printhead relative to a not-shown workpiece. The printhead housing 36 includes a cylindrical actuator holding portion 56 on its first (top) plate side to hold an actuator assembly 16.

In addition, a plate-shaped insulating component 50 is attached to the second (lower) plate side of the printhead housing 36; a crucible 40 is in turn attached to the lower side thereof (side that faces away from the printhead housing 36). The crucible 40 is thus attached to the printhead housing 36 via the insulating component 50, which creates a thermal insulation between the crucible 40 and the printhead housing 36.

The crucible 40 forms a supply reservoir 42 for storing already liquefied printing material, in particular molten metal. Alternatively, the molten metal can be generated in the crucible by supplying metal material, which has not yet been liquefied, in the crucible and melting the same. A heating device is provided to heat the crucible 40, which is here in the form of induction loops 58, which surround the crucible 40 in a ring-shaped manner, to inductively heat the molten metal. The heating device can, for example, also be formed integrated into the crucible wall. The crucible 40 is substantially pot-shaped or bowl-shaped, wherein the upper (open) edge is affixed to the insulating component 50.

The crucible 40 has a bottom hole 46 in the bottom region 44, in which the melt collects. In this embodiment, a piston guide component (here formed as a guide sleeve 60) is inserted in this bottom hole 46. The guide sleeve 60 has a (central) through hole, which forms the piston channel 22, in the y-direction. The piston channel 22 has overflow slots 48 in an upper region (a region that faces the supply reservoir 42). These overflow slots 48 are formed in the wall of the channel and extend along the piston channel 22 starting from the crucible interior space (supply reservoir 42). The outer diameter of the guide sleeve 60 decreases starting from the inner side of the crucible 40 outwardly, here in a step-like manner. The inner diameter of the bottom hole 46 decreases accordingly, so that the guide sleeve 60 is held in the bottom hole of the crucible 40 from the inside to the outside. Preferably, the guide sleeve 60 is press-fit into the bottom hole 46 of the crucible.

The lower end of the guide sleeve 60, which is opposite the supply reservoir 42, forms a bayonet coupling (details not shown) with a clamping component 62. By using the bayonet coupling, the nozzle component 10 (which is in the form of a nozzle plate) is clamped between the clamping component 62 and the lower end of the guide sleeve 60. The bayonet coupling is exemplary and can be replaced by other clamping mechanisms. The nozzle component (nozzle plate) 10 has a nozzle component through hole 20 extending in the y-direction, which opens into the nozzle outlet opening 12 on its underside (i.e. the side that faces away from the crucible interior space). Preferably, the nozzle component through hole tapers towards the nozzle outlet opening 12.

In addition, a piston 14 is provided that extends from the actuator assembly 16 into the piston channel 22. The piston 14 is formed such that a first piston end 18, which faces the nozzle assembly 10, ends in the piston channel 22. The first piston end 18 is preferably guided in the piston channel 22. Thus, the first piston end 18 has (is disposed with) a clearance fit in the piston channel 22. The nozzle outlet opening 12, the nozzle component through hole 20, the piston channel 22, the piston 14 and the actuator assembly 16, in particular the actuator and its actuation direction and the biasing element 26, all preferably lie on a line in the y-direction.

In addition, a supply channel 64 for the molten metal is preferably provided in the insulating component 50. In this embodiment, a gasket 66 is also provided between the insulating component 50 and the printhead housing 36. Thus, cooling channels 68 (for example for cooling water), which are provided in the printhead housing 36, are sealed by the gasket 66.

The actuator assembly 16 is, for example, press-fit into the actuator retaining region 56 or is preferably rigidly affixed via not-shown clamping means.

In addition, a controller 52 is provided to control the actuator assembly 16; the controller 52 is electrically connected with the actuator assembly 16 via a control line 54. The controller 52 is configured in a usual manner and includes, for example, a power supply, a CPU, an appropriate memory, and input and output means.

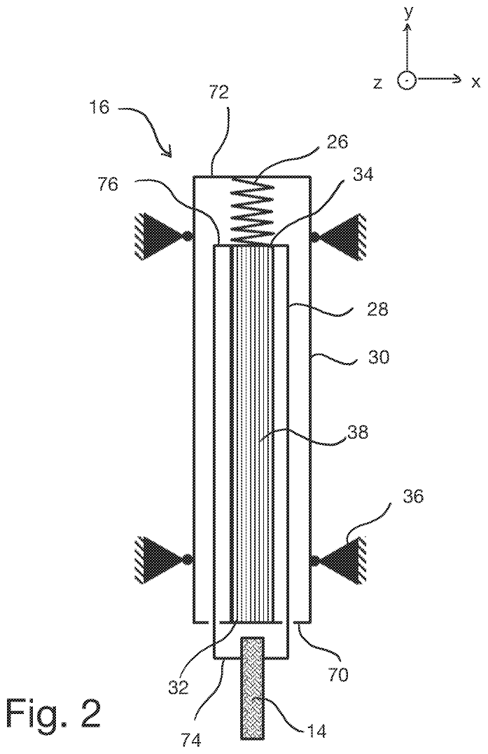

The actuator assembly 16 is described in more detail below with reference to FIG. 2. First, the actuator assembly 16 has a hollow actuator housing 30, here hollow cylindrical in the y-direction, that, as provided above, is rigidly connected to the printhead housing 36 in the installed state. The actuator housing 30 has a bottom wall 70 and a ceiling wall 72 in the y-direction, wherein the bottom wall 70 is closer to the nozzle outlet opening 12 than the ceiling wall 72.

A piezoelectric actuator 38 (here a piezoelectric stack) is provided in the interior of the actuator housing 30, which increases its length expansion, starting from a rest position in which it is discharged and no voltage is applied, in an actuation direction upon application of a voltage. The piezoelectric actuator 38 is arranged such that its actuation direction corresponds to the y-direction. In its actuation direction, the piezoelectric actuator 38 has a first end 32 and an opposite second end 34 that is disposed farther away from the nozzle outlet opening 12 than the first end 32. The first end 32 is supported on, preferably attached to, the inner side of the bottom wall 70 in the y-direction. The second end 34 is provided spaced from the ceiling wall 72.

In addition, a piston attachment 28 is provided in the interior of the actuator housing 30. The piston attachment 28 serves to connect the second end 34 of the piezoelectric actuator 38 with the piston 14, which is arranged in the y-direction parallel to the piezoelectric actuator 38 in the direction of the nozzle outlet opening 12 (in the figures, below). For this purpose, the piston attachment 28 is preferably formed as a hollow cylindrical component. The lower, first end 74 of the piston attachment 28 is attached to the piston 14 (for example by a screw connection). In this embodiment, the upper, second end of the piston attachment 28 is closed by a rigid cover and is disposed and/or formed such that the piezoelectric actuator 38 is accommodated therein and the second end 34 of the piezoelectric actuator 38 can abut on the inner side of the upper, second end of the piston attachment. As shown in FIG. 2, for this purpose the piston attachment 28 is provided radially (in a direction perpendicular to the y-direction) between the piezoelectric actuator 38 and the actuator housing 30 and extends through the bottom wall 70 of the actuator housing 30. For example, the bottom wall 70 has for this purpose a plurality of guide slots, which are arranged on a periphery of a circle distributed around the circumference. Corresponding guide sections of the piston attachment 28, which are provided in the y-direction, extend through the respective guide slots. For this purpose, the hollow cylindrical piston attachment 28 has corresponding longitudinal slots that extend in the y direction.

In addition, a biasing element 26 (here a compression spring in the form of a disc spring) is provided in the interior of the actuator housing 30, which is preferably provided with a preload between the upper second end of the piston attachment and the ceiling wall 72. Thus, a first, lower end of the biasing element 26 is supported in the y-direction on the outer side of the upper second end of the piston attachment 28 and a second, upper end of the biasing element 26 is supported in the y-direction on the inner side of the ceiling wall 72. The components may be merely supported against each other or may be affixed to each other by not-shown fasteners. The piston attachment 28 is thus biased by the biasing element 26 against the piezoelectric actuator 38 (its upper end), so that the piezoelectric actuator is biased to its rest position (retracted position). The length expansion in the actuation direction thus takes place starting from the rest position against a biasing force generated by the biasing element 26.

The printhead 1 and its individual components and the controller 52 are ultimately configured and attuned with each other such that, when no voltage is applied to the piezoelectric actuator 38 and the piezoelectric actuator 38 is discharged and the piston 14 is in its rest position, which corresponds to the extended position of the piston, the first piston end 18 is disposed close to the nozzle component 10. Accordingly, a so-called resting volume, which is formed on the side of the nozzle outlet opening 12 of the piston 14 and the nozzle component through hole 20 in this position of the piston 14 in the piston passage 22, is relatively small.

A (first) voltage can then be applied to the piezoelectric actuator 38 by the controller 52. By applying the voltage, the piezoelectric actuator 38 expands in the y-direction against the biasing force of the biasing element 26, which leads to a movement of the piston 14 in a direction away from the nozzle outlet opening 12. The volume available in the piston passage 22 in front of the piston 14 increases owing to this movement. The additional available volume will be referred to as loading chamber 24 (see FIG. 1). As the piston 14 moves upward, new molten metal can therefore flow through the overflow slots 28, which are formed in the wall of the piston channel 22, into and fill the newly-formed loading chamber. The movement is ultimately limited by the expandability of the piezoelectric actuator 38 and/or the increasing (counter) force of the biasing element 26.

After reaching the uppermost position, which corresponds to the retracted position of the piston 14 in which the volume of the loading chamber is at a maximum, the voltage at the piezoelectric actuator 38 is switched off by the controller 52 and it is discharged. Since the piezoelectric actuator 38 in this case no longer applies force counteracting the biasing force of the biasing element 26, the biasing element 26 pushes the piezoelectric actuator 38 back toward its starting position, whereby the piston 14, via the piston attachment 28, also moves back to its rest position (extended position).

In this movement back into the extended position, the molten metal in the loading chamber is displaced by the first piston end 18 and is moved toward the nozzle outlet opening 12. In particular, the loading chamber, the resting volume, the piston speed, the biasing force of the biasing element 26, the nozzle component 10 and the nozzle outlet opening 12 are thereby attuned with one another in a known manner such that the molten metal is ejected in this return movement while forming a droplet. The movement to the extended position is limited (stopped) by the piezoelectric actuator 38.

The piston 14 then remains in the rest position for a specified decay time before the next loading of the piezoelectric actuator 38 occurs.

It is understood that the piezoelectric actuator 38 used in the first embodiment can be readily replaced by other actuators.

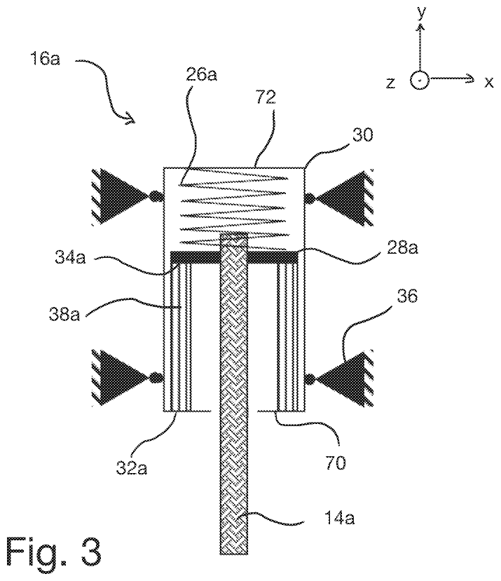

In the following, a second embodiment of the actuator assembly is described with reference to FIG. 3. Components which are identical or structurally similar to each other are marked with identical reference signs. For variant (alternate, modified) components having similar functions, an “a” is added to the originally used reference sign. To avoid repetition, only the essential differences are described.

Similar to the actuator assembly 16, the actuator assembly 16a also includes an actuator housing 30 having a bottom wall 70 and a ceiling wall 72, wherein the bottom wall 70 is disposed closer to the nozzle outlet opening 12. Unlike the actuator assembly 16 according to the first embodiment, a piezoelectric actuator 38a in the form of a ring piezoelectric is provided in the actuator assembly 16a according to the second embodiment. A first end 32a of the piezoelectric actuator 38a is supported on or attached to an inner side of the bottom wall 70.

In this embodiment, the piston attachment 28a is formed merely as a circular disc that lies on or is attached to the second end 34a of the piezoelectric actuator 38a. The piston attachment 28a serves, on the one hand, to support the biasing element 26a, which is provided between the ceiling wall 72 of the actuator housing 30 and the piston attachment 28a, and, on the other hand, to connect the piston 14a with the second end 34a of the piezoelectric actuator 38a. In this embodiment, the piston 14a extends through a central through hole, which is provided in the bottom wall 70, into the actuator housing 30. The piston 14a and/or its second end is connected with the piston attachment 28a, for example, via a threaded connection.

The operation of the embodiments is identical.

The embodiments may be modified in a wide variety of ways, as exemplified below:

For example, other types of actuators can be used. The piston attachment can be integral, i.e. made in one piece with the piston. The piston attachment can be rigidly mounted on the actuator, or only abut against it. The biasing element can merely abut against the actuator housing, or be attached thereto. The biasing element can merely abut against the piston attachment, or be attached thereto. Alternatively or additionally, the biasing element may merely abut against the actuator, or be attached thereto. The biasing element can be installed at any other location as long as it biases the piston, piston attachment, or actuator to the rest position and the components are coupled together such that the piston is in its extended position when the actuator is in the rest position. For example, in the first embodiment, the biasing element can be provided between the lower end of the piston attachment and the bottom wall of the actuator housing. In the second embodiment, the biasing element could be provided between an upper end of the piston and the ceiling wall of the actuator housing. In the case of the design as a tension spring, the biasing element can be disposed on the bottom wall and extend to the top end of the piezoelectric actuator.

It is explicitly emphasized that all features disclosed in the description and/or claims are to be considered separate and independent from each other for the purpose of the original disclosure as well as for the purpose of limiting the claimed invention regardless of the combinations of features in the embodiments and/or claims. It is explicitly stated that all range indications or indications of groups of units disclose any possible intermediate value or subset of units for the purpose of the original disclosure as well as for the purpose of limiting the claimed invention, in particular also as a limit of a range indication. The terms “approximately”, “about”, “circa”, “substantially” or “in general” as used herein in connection with a measurable value such as, for example, a parameter, a quantity, a form, a duration in time or the like, include deviations or variations of ±10% or less, preferably ±5% or less, further preferably ±1% or less and further preferably ±0.1% of the respective value or from the respective value, provided that such deviations are still technically reasonable when putting the disclosed invention into practice. It is expressly noted that the value to which the term “approximately” refers is disclosed as such explicitly and in particular. The indication of ranges by initial and final values includes all those values and fractions thereof which are included by the respective range, as well as its initial and final values.

### LIST OF REFERENCE SIGNS

1 Printhead
10 Nozzle component
12 Nozzle outlet
14, 14a Piston
16, 16a Actuator assembly
18 First piston end
20 Nozzle component through hole
22 Piston channel
24 Loading chamber
26; 26a Biasing element (spring element)
28, 28a Piston attachment
30 Actuator housing
32, 32a First end of piezoelectric actuator
34, 34a Second end of piezoelectric actuator
36 Printhead housing
38, 38a Piezoelectric actuator
40 Crucible
42 Supply reservoir
44 Bottom region
46 Bottom hole
48 Overflow slots
50 Insulating component
52 Controller
54 Control line
56 Actuator holding region
58 Heating coil
60 Guide sleeve
62 Clamping component
64 Supply channel
66 Gasket
68 Cooling channels
70 Bottom wall of the actuator housing
72 Ceiling wall of the actuator housing
74 Lower, first end of the piston attachment
76 Upper, second end of the piston attachment

1. A printhead for printing molten metal for additive manufacturing of a component, including:
a nozzle component having a nozzle outlet opening,
a piston configured to eject the molten metal through the nozzle outlet opening,
an actuator assembly having an actuator, and
a biasing element,
wherein:
by actuating the actuator, the piston is movable in an actuation direction (y) from an extended position to a retracted position, in which a first piston end that faces the nozzle outlet opening is farther away from the nozzle outlet opening than in the extended position, and
the biasing element biases the piston, at least when the piston is located in the retracted position, towards the extended position.

2. The printhead according to claim 1, wherein:
a nozzle component through hole is provided in the nozzle component, extends through the nozzle component and opens into the nozzle outlet opening,
a piston passage is in communication with the nozzle component through hole or is formed at least partially by the nozzle component through hole,
when the piston is located in the retracted position, a loading chamber for molten metal to be ejected is formed in front of the first piston end, the loading chamber being formed at least partially by the piston channel, and
when the piston is located in the extended position, the first piston end projects into the loading chamber.

3. The printhead according to claim 1, wherein the piston and the piston channel are configured such that:
the loading chamber fills with the molten metal during movement of the piston from the extended position to the retracted position, and/or
at least a portion of the molten metal, which is located between the piston and the nozzle outlet opening in the retracted position of the piston, is ejectable to the outside via the nozzle outlet opening during movement of the piston from the retracted position to the extended position.

4. The printhead according to claim 1, wherein:
the actuator is configured to move the piston from the extended position to the retracted position in response to the supply of energy to the actuator or in response to an increase in the supply of energy to the actuator, and
after ending of the supply or reduction of the supply of energy to the actuator, the biasing element is configured to move the piston back to the extended position.

5. The printhead according to claim 1, wherein:
the actuator assembly further comprises an actuator housing and a piston attachment that connects the piston to the actuator,
a first end of the actuator in the actuation direction (y) is connected to or abuts on the actuator housing, and
a second end of the actuator in the actuation direction (y) is connected to or abuts on the piston attachment.

6. The printhead according to claim 5, wherein:
the piston attachment is supported in the actuator housing so as to be movable in the actuation direction (y).

7. The printhead according to claim 5, wherein:
the actuator housing surrounds the piston attachment radially with reference to the actuation direction (y) and/or the piston attachment surrounds the actuator radially with reference to the actuation direction (y), and/or
the actuator housing and/or the piston attachment are hollow cylindrical.

8. The printhead according to claim 5, wherein:
the biasing element is provided between, on the one side, the actuator housing or a component supported on the actuator housing in the actuation direction (y) and, on the other side, the piston or a component supported on the piston in the actuation direction (y) or the piston attachment, or
the biasing element is provided between, on the one side, the actuator housing or a component supported by the actuator housing in the actuation direction (y) and, on the other side, the second end of the actuator.

9. The printhead according to claim 1, wherein:
the actuator is or comprises a piezoelectric actuator that is expandable from a first length to a second length in the actuation direction (y) in response to application of a voltage, and
the piston is configured to move from the extended position to the retracted position as the piezoelectric actuator expands from the first length to the second length.

10. The printhead according to claim 1, further comprising:
a crucible, which is heatable by a heater, and serves as a supply reservoir for the molten metal,
wherein:
a bottom hole is provided in a bottom region of the crucible,
the nozzle component is inserted into the bottom hole or the molten metal can flow through the bottom hole into the nozzle component through hole, and
the actuator is provided on a side of the crucible that is opposite the bottom region in the actuation direction (y).

11. The printhead according to claim 10, further comprising:
a printhead housing (36),
wherein:
the printhead housing is integrally formed with an actuator housing or the actuator housing is mounted on the printhead housing, and/or
the crucible is mounted on the printhead housing directly or via an insulating component that provides a thermal insulation.

12. The printhead according to claim 11, wherein:
the supply reservoir of the crucible is in fluid communication with the loading chamber when the piston is located in the retracted position, and/or
when the piston is located in the retracted position, the piston projects into the piston channel, and overflow slots are provided in the wall of the nozzle component through hole and/or in the outer wall of the piston, the overflow slots being configured to enable an inflow of molten metal into the loading chamber when the piston is located in the retracted position.

13. A method of operating the printhead according to claim 1, comprising:
filling the loading chamber with molten metal by actuating the actuator to move the piston from the extended position to the retracted position against the biasing force of the biasing element,
ending the actuation of the actuator, and
generating and ejecting of a droplet of the molten metal by returning the piston to the extended position using the biasing force of the biasing element.

14. The method according to claim 13, wherein for generating and ejecting a plurality of droplets in succession:
waiting a predetermined decay time after the piston has returned to the extended position takes place before refilling of the loading chamber with molten metal by actuating the actuator.

15. The method according to claim 13, wherein:
the step of filling by moving the piston from the extended position to the retracted position utilizes between 60% to 90% of a total movement time that is required for the piston to move from the extended position to the retracted position and back to the extended position, and/or
the piston does not pause in the retracted position.

16. The printhead according to claim 3, wherein:
the actuator is configured to move the piston from the extended position to the retracted position in response to the supply of energy to the actuator or in response to an increase in the supply of energy to the actuator, and
after ending of the supply or reduction of the supply of energy to the actuator, the biasing element is configured to move the piston back to the extended position.

17. The printhead according to claim 16, wherein:
the actuator assembly further comprises an actuator housing and a piston attachment that connects the piston to the actuator,
a first end of the actuator in the actuation direction (y) is connected to or abuts on the actuator housing, and
a second end of the actuator in the actuation direction (y) is connected to or abuts on the piston attachment,
the piston attachment is supported in the actuator housing so as to be movable in the actuation direction relative to the actuator housing.

18. The printhead according to claim 17, wherein:
the actuator housing surrounds the piston attachment radially with reference to the actuation direction (y) and/or the piston attachment surrounds the actuator radially with reference to the actuation direction (y), and
the actuator housing and/or the piston attachment are hollow cylindrical.

19. The printhead according to claim 18, wherein:
the biasing element extends: between (i) the actuator housing or a component supported on the actuator housing in the actuation direction (y) and (ii) one of the piston, a component supported on the piston in the actuation direction (y), the piston attachment or the second end of the actuator,
the actuator is or comprises a piezoelectric actuator that is expandable from a first length to a second length in the actuation direction (y) in response to application of a voltage, and
the piston is moved from the extended position to the retracted position in response to the piezoelectric actuator expanding from the first length to the second length.

20. The printhead according to claim 19, further comprising:
a crucible configured to be heatable by a heater, the crucible defining a supply reservoir for the molten metal, and
a printhead housing,
wherein:
a bottom hole is provided in a bottom region of the crucible,
the nozzle component is inserted into the bottom hole or the molten metal can flow through the bottom hole into the nozzle component through hole,
the actuator is provided on a side of the crucible that is opposite the bottom region in the actuation direction (y).
the printhead housing is integrally formed with the actuator housing or the actuator housing is mounted on the printhead housing, and/or the crucible is mounted on the printhead housing directly or via an insulating component that provides a thermal insulation,
the supply reservoir of the crucible is in fluid communication with the loading chamber when the piston is located in the retracted position, and
when the piston is located in the retracted position, the piston projects into the piston channel, and overflow slots provided in the wall of the nozzle component through hole and/or in the outer wall of the piston enable an inflow of molten metal into the loading chamber when the piston is located in the retracted position.
